(19) United States
(12) Patent Application Publication
(10) Pub. No.: US 2015/0103086 A1
(43) Pub. Date: Apr. 16, 2015

(54) DISPLAY DEVICE WITH GRAPHICS FRAME COMPRESSION AND METHODS FOR USE THEREWITH

(71) Applicant: ViXS Systems, Inc., Toronto (CA)

(72) Inventor: Chun-Chin Yeh, Markham (CA)

(21) Appl. No.: 14/053,219

(22) Filed: Oct. 14, 2013

(51) Int. Cl. G09G 5/36; H04N 19/433; H04N 19/40

(52) U.S. Cl. CPC G09G 5/36; H04N 19/40; H04N 19/433; G09G 2360/12; G09G 2360/18
USPC 345/547

(57) ABSTRACT

A display device includes an uncompressed graphical frame buffer that buffers uncompressed graphical frame data. The display device reads the uncompressed graphical frame data from the uncompressed graphical frame buffer for display in conjunction with a first frame of the plurality of video frames. A compression/decompression engine writes the uncompressed graphical frame data to a compressed graphical frame buffer. The video display device reads the compressed graphical frame data from the compressed graphical frame buffer via the compression/decompression engine for display in conjunction with a second frame of the plurality of video frames.

### CROSS REFERENCES TO RELATED APPLICATIONS

The present application is related to the application entitled, VIDEO PROCESSOR WITH FRAME BUFFER COMPRESSION AND METHODS FOR USE THEREWITH, having application Ser. No. 13/933,281, filed on Jul. 2, 2013; that claims priority under 35 U.S.C. 119 to the provisionally filed application entitled, VIDEO PROCESSOR WITH FRAME BUFFER COMPRESSION AND METHODS FOR USE THEREWITH, having application Ser. No. 61/755,280, filed on Jan. 22, 2013; the contents of which are incorporated herein by reference thereto.

### TECHNICAL FIELD OF THE INVENTION

The present invention relates to encoding used in devices such as video display devices.

### DESCRIPTION OF RELATED ART

A frame buffer is memory buffer used in conjunction with a video display device to store a complete frame of video or graphical data. The frame buffer typically contains color values for every pixel of the screen. In many modern devices, the frame buffer is implemented in a memory that is external to the device. This is often done when the video or graphic frame is too big to be stored in memory within the device itself. As pixel resolution of the video or graphical frames increase, the memory bandwidth required by the processing of these video frames also increases. Memory bandwidth can be a consideration in designing such video devices.

Further limitations and disadvantages of conventional and traditional approaches will become apparent to one of ordinary skill in the art through comparison of such systems with the present invention.

### BRIEF DESCRIPTION OF THE SEVERAL VIEWS OF THE DRAWINGS

FIGS. 1-3 present pictorial diagram representations of devices in accordance with embodiments of the present invention;

FIG. 4 presents a block diagram representation of a display subsystem 125 in accordance with an embodiment of the present invention;

FIG. 5 presents a block diagram representation of a data object compression in accordance with an embodiment of the present invention;

FIG. 6 presents a graphical representation of compressed data object 264 in accordance with an embodiment of the present invention;

FIG. 7 presents a flowchart representation of a method in accordance with an embodiment of the present invention;

FIG. 8 presents a flowchart representation of a method in accordance with an embodiment of the present invention;

FIG. 9 presents a flowchart representation of a method in accordance with an embodiment of the present invention; and

FIG. 10 presents a flowchart representation of a method in accordance with an embodiment of the present invention.

### DETAILED DESCRIPTION OF THE INVENTION INCLUDING THE PRESENTLY PREFERRED EMBODIMENTS

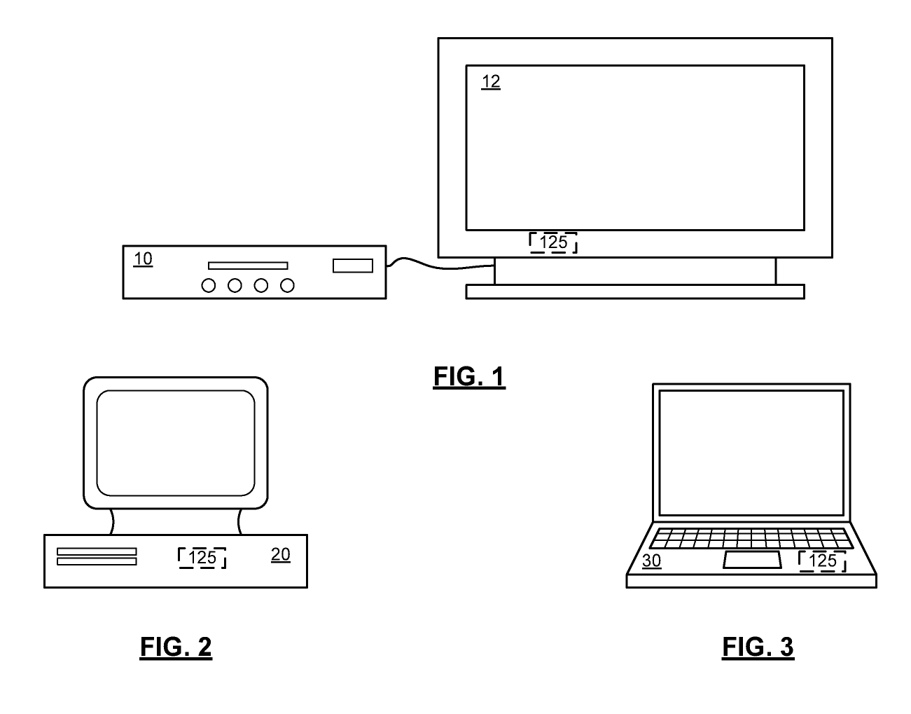

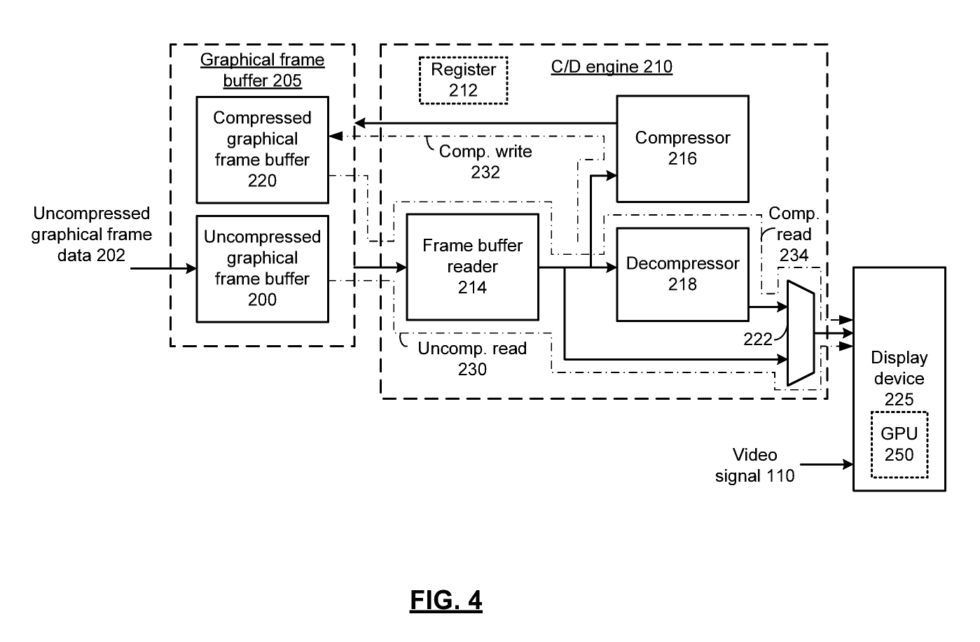

FIGS. 1-3 present pictorial diagram representations of devices in accordance with embodiments of the present invention. In particular, television 12 that operates alone or in conjunction with a set top box 10 with built-in digital video recorder functionality, Internet TV appliance or digital video player, can include a display subsystem 125 that includes one or more features or functions of the present invention. Computer 20 and portable computer 30, such a laptop computer, tablet or smartphone that incorporate a display subsystem 125 illustrate further examples of electronic devices that include one or more features or functions of the present invention.

While these particular devices are illustrated, display subsystem 125 includes any device that is capable of buffering graphical frame data in accordance with the methods and systems described in conjunction with FIGS. 4-10 and the appended claims.

FIG. 4 presents a block diagram representation of a display subsystem 125 in accordance with an embodiment of the present invention. In particular, display subsystem 125 includes a graphical frame buffer 205, compression/decompression engine 210, and a display device 225.

Display device 225 can include a television, monitor, computer, handheld device or other video display device that creates an optical image stream either directly or indirectly, such as by projection, based on decoding the uncompressed graphical frame data 202. The uncompressed graphical frame data includes graphical data in one or more data planes or surfaces that are presented for display on the display device 225 in conjunction with a plurality of video frames, with or without an accompanying video derived from optional video signal 110. The display device 225 optionally includes a graphics processing unit 250 that operates to process graphical and video data and optionally to decode video data received separately from the uncompressed graphical frame data. When present, a video signal 110, once decoded, is optionally processed, scaled, and blended with graphical objects or menus for display on the display device 225.

In an embodiment of the present invention, the video signal 110 can be a broadcast video signal, such as a high definition televisions signal, enhanced high definition television signal or other broadcast video signal that has been transmitted over a wireless medium, either directly or through one or more satellites or other relay stations or through a cable network, optical network or other transmission network. In addition, video signal 110 can be generated from a stored video file, played back from a recording medium such as a magnetic tape, magnetic disk or optical disk, and can include a streaming video signal or video download signal that is transmitted over a public or private network such as a local area network, wide area network, metropolitan area network or the Internet. Video signal 110 can be digital video signal that are formatted in accordance with a codec standard such as Home Digital Media Interface (HDMI), H.264, MPEG-4 Part 10 Advanced Video Coding (AVC) VC1 or other digital format such as a Motion Picture Experts Group (MPEG) format (such as MPEG1, MPEG2 or MPEG4), Quicktime format, Real Media format, or Windows Media Video (WMV) or another digital video format, either standard or proprietary.

The graphical frame buffer 205 includes a compressed graphical frame buffer 220 and an uncompressed graphical frame buffer 200. The compressed graphical frame buffer 220 and an uncompressed graphical frame buffer 200 can be different portions of a common memory or can be implemented via separate devices. The memory or memories can includes a hard disk drive or other disk drive, read-only memory, random access memory, volatile memory, non-volatile memory, static memory, dynamic memory, flash memory, cache memory, and/or any device that stores digital information.

In operation, the uncompressed graphical frame buffer 200 stores uncompressed graphical frame data 202. The compressed graphical frame buffer stores compressed graphical frame data.

The video display device 225 displays at least one graphical plane over a plurality of video frames. The operation of the display device 225 includes reading the uncompressed graphical frame data 202 from the uncompressed graphical frame buffer 200 for display in conjunction with a first frame of the plurality of video frames. In particular, the display device 225 can generate a read command to the uncompressed graphics frame buffer 200 and operates via frame buffer reader 214 to retrieve the uncompressed graphical frame data 202 via uncompressed read 230.

When the uncompressed graphical frame data 202 is retrieved, the compression/decompression engine 210 generates the compressed graphical frame data for storage in the compressed graphical frame buffer 220. In particular, the compressor 216 operates by compressing the uncompressed graphical frame data 202 to form compressed graphical frame data that is written to the compressed frame buffer 220 as shown by compressed write 232. The demultiplexor 222 selects direct output of frame buffer reader 214 for uncompressed reads 230.

The display device 225 further operates by reading the uncompressed graphical frame data 202 from the compressed graphical frame buffer 220 via compressed read 234 from compression/decompression engine 225 for display in conjunction with a second frame of the plurality of video frames. In particular, the compression/decompression engine 210 retrieves the uncompressed graphical frame data 202 by decompressing the compressed graphical frame data stored in the compressed graphical frame buffer 220. Compressed read 234 operates by first retrieving the compressed graphical frame data from the compressed graphical frame buffer 220 via frame buffer reader 214 and then regenerating the uncompressed graphical frame data 202 by decompressing the compressed graphical frame data via decompressor 218. The demultiplexor 222 selects the output of decompressor 218 for compressed reads 234 and the direct output of frame buffer reader 214 for uncompressed reads 230. In an embodiment, the compression/decompression engine 210 further includes at least one register 212 that defines a range of memory addresses corresponding to the compressed graphical frame buffer 220.

The display device 225 further operates by reading the uncompressed graphical frame data 202 from the compressed graphical frame buffer 220 via compressed read 234 from compression/decompression engine 225 for display in conjunction with a third frame of the plurality of video frames and any subsequent frame until the uncompressed graphical frame data 202 changes and the process begins again by a new uncompressed read 230 and a new compressed write 232.

The compression/decompression engine 210 and graphics processing unit 250 can be implemented using a single processing device or a plurality of processing devices. Such a processing device may be a microprocessor, co-processors, a micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions that are stored in a memory. Such a memory device can also include a hard disk drive or other disk drive, read-only memory, random access memory, volatile memory, non-volatile memory, static memory, dynamic memory, flash memory, cache memory, and/or any device that stores digital information. Note that when the processing module implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry.

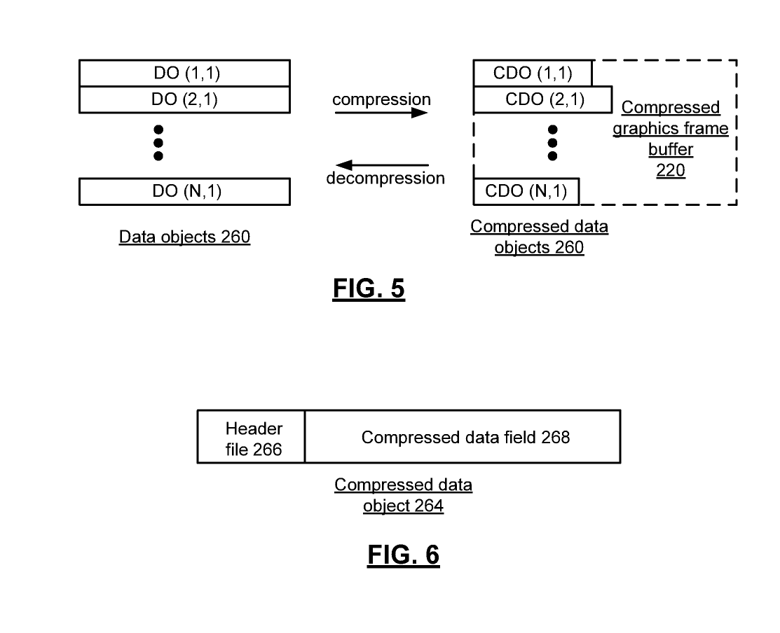

FIG. 5 presents a block diagram representation of a data object compression in accordance with an embodiment of the present invention. In particular, an embodiment for data compression and decompression performed by compression/decompression engine 210 is presented. It is often not feasible to compress an entire graphical frame as a whole because later picture processing may only need a small part of that frame. In operation, the compression/decompression engine 210 operates to segment uncompressed graphical frame data 202 into smaller data objects (DOs) that are compressed into compressed data objects (CDOs) in a fashion to offer random accessibility to portions of the frame data.

As shown, each data object (DO) 260 is compressed individually into a corresponding compressed data object (CDO) 262. As shown, the compressed data objects 262 can be of different sizes based on the amount of compression for each data object 260. Each compressed data object 262 is stored in a predetermined location in a portion of compressed graphics buffer 220, such as a range of addresses reserved for compressed graphical frame data. As discussed in conjunction with FIG. 4, the compression/decompression engine 210 includes one or more registers 212 that define a range of memory addresses corresponding to the compressed graphical frame buffer.

In an embodiment, each compressed data object 262 is stored at a base memory address at a corresponding predetermined location in memory. For example, the locations of data objects in a graphical frame can be predetermined, based on the size of the frame, resolution, etc. Each data object 260 can be associated with a base memory address in a portion of compressed graphics buffer 220 corresponding to the location where the compressed data object 262 corresponding to that particular data object 260 will be stored.

FIG. 6 presents a graphical representation of compressed data object 264 in accordance with an embodiment of the present invention. As indicated in FIG. 5 the compressed data objects 262 can be of different sizes based on the amount of compression for each data object 260. In operation, the compression/decompression engine compresses the data object 260, generates a header file 266 that indicates the size of the compressed data for each compressed data object 262 and stores the compressed data in compressed data field 268.

When a compressed read command is received from display device 225 corresponding to an entire frame, the compression decompression reads each of the compressed data objects 262, decompresses the compressed data objects 262 to regenerate data objects 260 and then desegments the data objects 260 to reconstitute the frame to implement compressed read 234. When only a region of a graphical frame is needed, the compression/decompression engine 210 first identifies selected ones of compressed data objects 262 that correspond to the selected portion of frame. The compression decompression module 210 then calculates the location of the required data objects in memory by determining the corresponding base memory addresses of each compressed data object 262. The compression decompression module 252 fetches the correct size for each compressed data object 262 by reading the corresponding header file 266, retrieving the compressed data field 268 based on the size, and decompressing the compressed data field to regenerate the data object(s) 260.

While the description of FIGS. 5 and 6 above contemplates line-by-line segmentation, compression and storage, other segments, such as blocks, or macroblocks can be employed. In a further embodiment, an entire picture can be compressed or decompressed without segmentation. Further, other compression and decompression methods can likewise be employed.

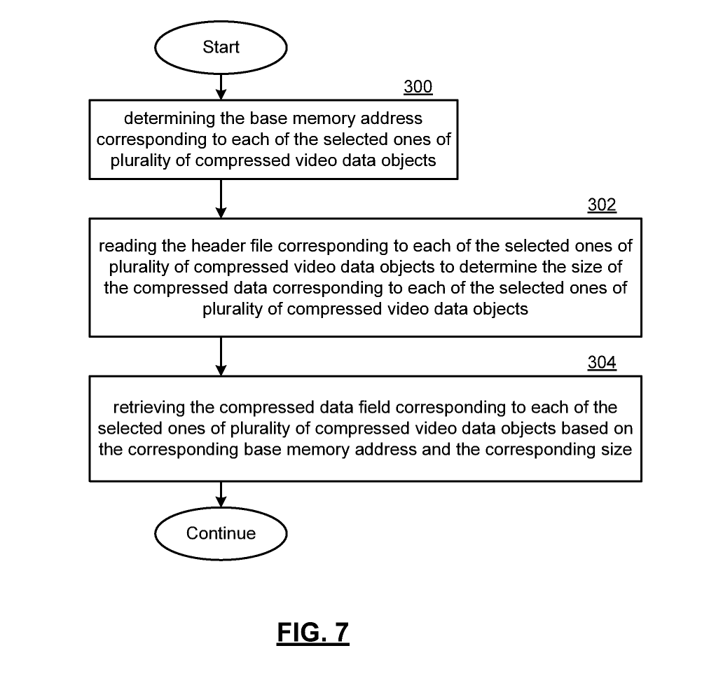

FIG. 7 presents a flowchart representation of a method in accordance with an embodiment of the present invention. In particular, a method is presented for use in conjunction with one or more of the features and functions described in association with FIGS. 1-6. In an embodiment, each of the compressed video data objects includes a header file that indicates a size of the compressed data contained therein and a compressed data field. Step 510 includes determining the base memory address corresponding to each of the selected ones of plurality of compressed video data objects. Step 512 includes reading the header file corresponding to each of the selected ones of plurality of compressed video data objects to determine the size of the compressed data corresponding to each of the selected ones of plurality of compressed video data objects. Step 514 includes retrieving the compressed data field corresponding to each of the selected ones of plurality of compressed video data objects based on the corresponding base memory address and the corresponding size.

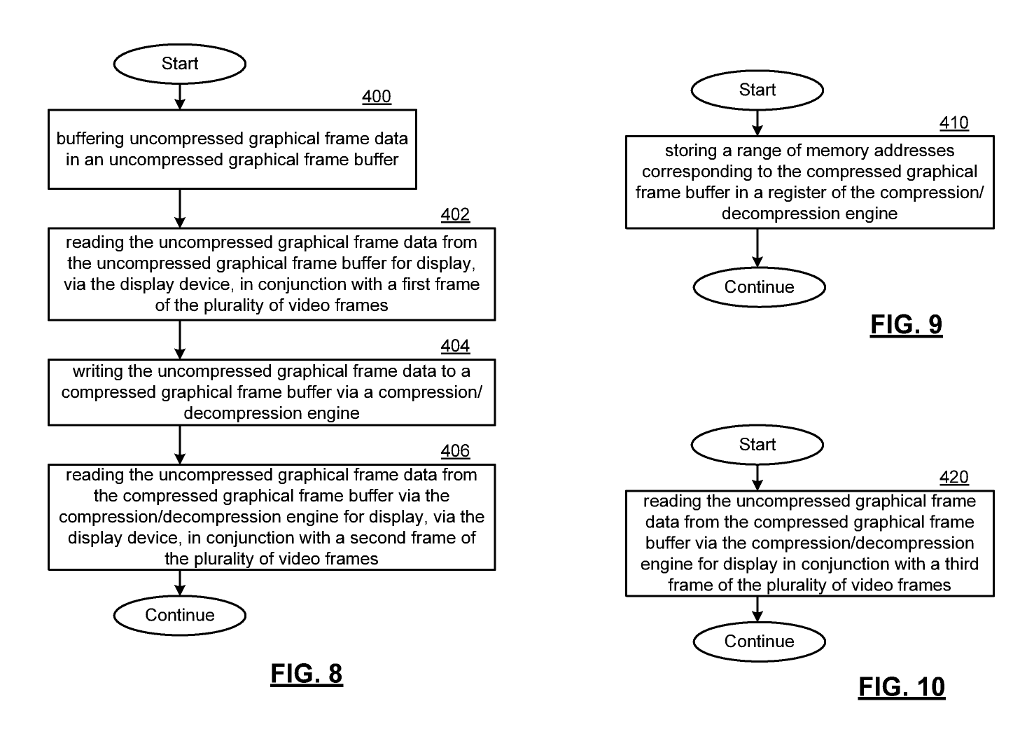

FIG. 8 presents a flowchart representation of a method in accordance with an embodiment of the present invention. A method is presented for use in conjunction with one or more functions and features described in conjunction with FIGS. 1-7. Step 400 includes buffering uncompressed graphical frame data in an uncompressed graphical frame buffer. Step 402 includes reading the uncompressed graphical frame data from the uncompressed graphical frame buffer for display, via the display device, in conjunction with a first frame of the plurality of video frames. Step 404 includes writing the uncompressed graphical frame data to a compressed graphical frame buffer via a compression/decompression engine. Step 406 includes reading the uncompressed graphical frame data from the compressed graphical frame buffer via the compression/decompression engine for display, via the display device, in conjunction with a second frame of the plurality of video frames.

In an embodiment, step 404 includes writing the compressed graphical frame data includes segmenting the uncompressed graphical frame data into a plurality of data objects and compressing the plurality of data objects into a plurality of compressed data objects and storing the plurality of compressed data objects in the compressed graphical frame buffer. In an embodiment, step 406 includes retrieving the plurality of compressed data objects, decompressing the plurality of compressed data objects.

FIG. 9 presents a flowchart representation of a method in accordance with an embodiment of the present invention. A method is presented for use in conjunction with one or more functions and features described in conjunction with FIGS. 1-8. Step 410 includes storing a range of memory addresses corresponding to the compressed graphical frame buffer in a register of the compression/decompression engine.

FIG. 10 presents a flowchart representation of a method in accordance with an embodiment of the present invention. A method is presented for use in conjunction with one or more functions and features described in conjunction with FIGS. 1-9. Step 420 includes reading the uncompressed graphical frame data from the compressed graphical frame buffer via the compression/decompression engine for display in conjunction with a third frame of the plurality of video frames.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “operably coupled to”, “coupled to”, and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

As may also be used herein, the terms “processing module”, “processing circuit”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

The present invention has been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

The present invention may have also been described, at least in part, in terms of one or more embodiments. An embodiment of the present invention is used herein to illustrate the present invention, an aspect thereof, a feature thereof, a concept thereof, and/or an example thereof. A physical embodiment of an apparatus, an article of manufacture, a machine, and/or of a process that embodies the present invention may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “unit”, also referred to as a “module”, is used in the description of the various embodiments of the present invention. A module includes a processing module, a functional block, hardware, and/or software stored on memory for execution by a processing device that performs one or more functions as may be described herein. Note that, if the module is implemented via hardware, the hardware may operate independently and/or in conjunction software and/or firmware. As used herein, a module may contain one or more sub-modules, each of which may be one or more modules.

While particular combinations of various functions and features of the present invention have been expressly described herein, other combinations of these features and functions are likewise possible. The present invention is not limited by the particular examples disclosed herein and expressly incorporates these other combinations.

What is claimed is:

1. A display subsystem comprising:
an uncompressed graphical frame buffer that stores uncompressed graphical frame data;
a compressed graphical frame buffer that stores compressed graphical frame data;
a compression/decompression engine, coupled to the uncompressed graphical frame buffer and the compressed graphical frame buffer, that generates the compressed graphical frame data for storage in the compressed graphical frame buffer by compressing the uncompressed graphical frame data and further that retrieves the compressed graphical frame data from the compressed graphical frame buffer and regenerates the uncompressed graphical frame data; and
a video display device, coupled to the coupled to the uncompressed graphical frame buffer and the compression/decompression engine, that displays at least one graphical plane over a plurality of video frames by:
reading the uncompressed graphical frame data via an uncompressed read from the uncompressed graphical frame buffer for display in conjunction with a first frame of the plurality of video frames; and
reading the uncompressed graphical frame data from the compressed graphical frame buffer via a compressed read from the compression/decompression engine for display in conjunction with a second frame of the plurality of video frames.

2. The video display subsystem of claim 1 wherein the compression/decompression engine generates the compressed graphical frame data for storage in the compressed graphical frame buffer by segmenting the uncompressed graphical frame data into a plurality of data objects and compressing the plurality of data objects into a plurality of compressed data objects.

3. The video display subsystem of claim 2 wherein the compression/decompression engine retrieves the compressed graphical frame data from the compressed graphical frame buffer by retrieving the plurality of compressed data objects.

4. The video display subsystem of claim 3 wherein the compression/decompression engine regenerates the uncompressed graphical frame data by decompressing the plurality of compressed data objects.

5. The video display subsystem of claim 1 wherein the compression/decompression engine includes at least one register that defines a range of memory addresses corresponding to the compressed graphical frame buffer.

6. The video display subsystem of claim 1 wherein the display device processes the at least one graphical plane of the video signal over the plurality of video frames of the video signal by further:
reading the uncompressed graphical frame data from the compressed graphical frame buffer via the compression/decompression engine for display in conjunction with a third frame of the plurality of video frames.

7. A method for use in conjunction with a display device, the method comprising:
buffering uncompressed graphical frame data in an uncompressed graphical frame buffer;
reading the uncompressed graphical frame data from the uncompressed graphical frame buffer for display, via the display device, in conjunction with a first frame of the plurality of video frames;
writing the uncompressed graphical frame data to a compressed graphical frame buffer via a compression/decompression engine; and
reading the uncompressed graphical frame data from the compressed graphical frame buffer via the compression/decompression engine for display, via the display device, in conjunction with a second frame of the plurality of video frames.

8. The method of claim 7 wherein writing the uncompressed graphical frame data includes segmenting the uncompressed graphical frame data into a plurality of data objects and compressing the plurality of data objects into a plurality of compressed data objects.

9. The method of claim 8 wherein writing the uncompressed graphical frame data further includes storing the plurality of compressed data objects in the compressed graphical frame buffer.

10. The method of claim 9 wherein reading the uncompressed graphical frame data from the compressed graphical frame buffer includes retrieving the plurality of compressed data objects.

11. The method of claim 10 wherein reading the uncompressed graphical frame data from the compressed graphical frame buffer further includes decompressing the plurality of compressed data objects.

12. The method of claim 7 further comprising:
storing a range of memory addresses corresponding to the compressed graphical frame buffer in a register of the compression/decompression engine.

13. The method of claim 7 further comprising:
reading the uncompressed graphical frame data from the compressed graphical frame buffer via the compression/decompression engine for display in conjunction with a third frame of the plurality of video frames.
